(19) United States
(12) Patent Application Publication
(10) Pub. No.: US 2016/0362869 A1
(43) Pub. Date: Dec. 15, 2016

(54) LINKAGE SYSTEM FOR COUPLING SNUBBER TO A MACHINE IMPLEMENT

(71) Applicant: Caterpillar Global Mining LLC, Oak Creek, WI (US)

(72) Inventors: Daniel E. Bozich, Milwaukee, WI (US); Carl D. Gilmore, South Milwaukee, WI (US); Vijay Venkataraman, Chennai (IN)

(73) Assignee: Caterpillar Global Mining LLC, Oak Creek, WI (US)

(21) Appl. No.: 14/735,186

(22) Filed: Jun. 10, 2015

(51) Int. Cl. E02F 3/407; F16H 21/44

(52) U.S. Cl. CPC E02F 3/4075; F16H 21/44

(57) ABSTRACT

A linkage system for a snubber of a machine is provided. The snubber is being mounted on an implement of the machine. The linkage system includes a first linkage component operatively coupled to the snubber. The first linkage component defines a plurality of apertures therein. The linkage system also includes a second linkage component having a first end distal to the first linkage component and a second end proximate the first linkage component. The first end of the second linkage component is pivotally coupled to a door of the implement about a door pivot axis. The second end of the second linkage component is selectively and pivotally coupled to one of the plurality of apertures about a link pivot axis in order to change a perpendicular distance between the door pivot axis and the link pivot axis.

### TECHNICAL FIELD

The present disclosure relates to a dipper system for a machine, and more specifically to a linkage system for the dipper system.

### BACKGROUND

Machines such as, rope shovels typically include an implement, such as a dipper, for loading and unloading materials. The dipper may include a door that closes a rear of the dipper to hold the materials that are loaded into the dipper. Further, the door is opened to unload the contents of the dipper at a desired location. The door may be typically held closed by a latch mechanism. The latch mechanism may be released to allow the door to swing open under its own weight and the weight of the contents of the dipper. The door may be re-latched as the door rotates back in preparation for its next loading cycle.

During the swinging movement, the door may tend to hit against walls of the dipper or any other proximal component. Sudden opening and closing of the door may also cause wear to components associated with the door. Typically, dippers may be equipped with a snubber on the door to reduce a swing speed as the door swings towards an open and/or closed position. Conventionally the snubbers may be mounted by a linkage system to the dipper body at a specific torque. However, during operation of the machine or wear of the snubber or other components, a resistance of the door and/or torque at the snubber may need to be adjusted.

For reference, U.S. Pat. No. 2,374,108 relates to a dipper door latching mechanism. The latching mechanism includes a cross member rigidly secured to one face or the dipper door. The cross member is provided with a centrally disposed passageway and a plurality of apertures disposed on opposite sides of the passageway at right angles thereto. The latching mechanism also includes a latch bar slidably mounted in the passageway. The latch lever bar is pivotally connected intermediate its ends to one end of latch lever bar that is selectively connected for pivotal movement to one of the openings.

### SUMMARY OF THE DISCLOSURE

In one aspect of the present disclosure, a linkage system for a snubber of a machine is provided. The snubber is being mounted on an implement of the machine. The linkage system includes a first linkage component operatively coupled to the snubber. The first linkage component defines a plurality of apertures therein. The linkage system also includes a second linkage component having a first end distal to the first linkage component and a second end proximate the first linkage component. The first end of the second linkage component is pivotally coupled to a door of the implement about a door pivot axis. The second end of the second linkage component is selectively and pivotally coupled to one of the plurality of apertures about a link pivot axis in order to change a perpendicular distance between the door pivot axis and the link pivot axis.

In another aspect of the present disclosure, a linkage system for a snubber of a machine is provided. The snubber is being mounted on an implement of the machine. The implement has a door. The linkage system includes a first linkage component operatively coupled to the snubber. The linkage system also includes a second linkage component having a first end distal to the first linkage component and a second end proximate the first linkage component. The second end of the second linkage component is pivotally coupled to the first linkage component about a link pivot axis. The linkage system includes a third linkage component mounted on the door of the implement. The third linkage component defines a plurality of holes therein. The first end of the second linkage component is selectively and pivotally coupled to one of the plurality of holes about a door pivot axis to change a perpendicular distance between the link pivot axis and the door pivot axis.

In yet another aspect of the present disclosure, a linkage system for a snubber of a machine is provided. The snubber is being mounted on an implement of the machine. The implement has a door. The linkage system includes a first linkage component operatively coupled to the snubber. The first linkage component defines a plurality of apertures therein. The linkage system also includes a second linkage component having a first end distal to the first linkage component and a second end proximate the first linkage component. The second linkage component defines a plurality of openings adjacent to the second end. One of the plurality of openings of the second linkage component is selectively and pivotally coupled to one of the plurality of apertures of the first linkage component about a link pivot axis. The linkage system further includes a third linkage component mounted on the door of the implement. The third linkage component defines a plurality of holes therein. The first end of the second linkage component is selectively and pivotally coupled to one of the plurality of holes about a door pivot axis.

Other features and aspects of this disclosure will be apparent from the following description and the accompanying drawings.

### BRIEF DESCRIPTION OF THE DRAWINGS

FIG. 1 is a side view of an exemplary machine having an implement, according to an embodiment of the present disclosure;

FIG. 2 is a partial perspective view of the implement showing a linkage system, according to one embodiment of the present disclosure;

FIG. 3 is a partial perspective view of the implement showing a linkage system, according to another embodiment of the present disclosure; and

FIG. 4 is a partial side view of the implement showing a linkage system, according to yet another embodiment of the present disclosure.

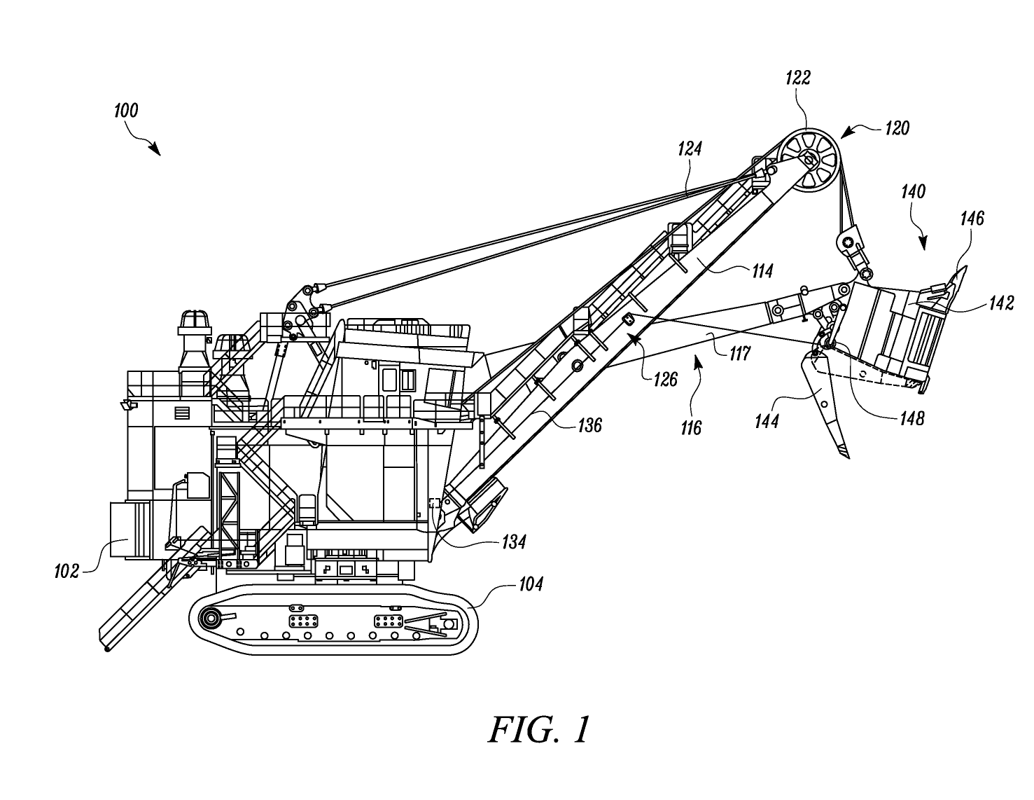

### DETAILED DESCRIPTION

Wherever possible, the same reference numbers will be used throughout the drawings to refer to the same or the like parts. Referring to FIG. 1, an exemplary machine 100 is illustrated, according to an embodiment of the present disclosure. The machine 100 is embodied as a rope shovel. Various embodiments of the present disclosure are described with reference to a rope shovel as the machine 100. However, the present disclosure may also be applicable to other types of machines such as, but not limited to, a hydraulic shovel and a dragline excavator.

The machine 100 includes a frame 102 that is configured to mount and/or support various components of the machine 100. The frame 102 is rotatably supported on a set of ground engaging members, for example, tracks 104 that are configured to propel the machine 100 forward or backward on ground. The tracks 104 may also be configured to turn the machine 100 by varying a speed and/or a direction of each of the tracks 104 relative to each other. Further, the machine 100 may be configured to move between a loading position and an unloading position relative to the tracks 104.

The machine 100 may also include a boom 114 extending upwardly and outwardly from the frame 102. The machine 100 may also includes a crowd mechanism 116 and a hoist mechanism 120 provided on the boom 114. The crowd mechanism 116 includes a handle 117 that is configured to slidably move with respect to the boom 114. The hoist mechanism 120 may include a winch (not shown), a pulley 122 and a hoist cable 124. The hoist cable 124 is connected to the winch at one end.

Referring now to FIG. 1, an implement 140 for the machine 100 is illustrated, according to an exemplary embodiment. In the illustrated embodiment, a dipper system 140 is embodied as the implement 140. The dipper system 140 may be configured to hold earth and/or other materials that may be loaded into the dipper system 140. The dipper system 140 includes a dipper body 142 and a dipper door 144 that is pivotally coupled to the dipper body 142. In the illustrated embodiment, the dipper system 140 may act as an implement of the machine 100. However, in various other embodiments, other tools having a movable component, such as a grapple may act as the implement 140.

Further, an other end of the hoist cable 124 extends over the pulley 122 and is connected to the dipper system 140. Based on a rotation of the winch, the cable retracts or extends relative to the winch. Accordingly, the hoist mechanism 120 is configured to raise or lower the dipper system 140 relative to the frame 102. Moreover, the dipper system 140 may extend or retract relative to the frame 102 based on the sliding movement of the handle 117.

The machine 100 may include a dipper trip mechanism 126 that is coupled to the door 144. The dipper trip mechanism 126 may be configured to operate the door 144. The dipper trip mechanism 126 may include a trip motor 134 and a trip cable 136 extending between the trip motor 134 and the door 144. More specifically, the trip cable 136 may be coupled to a locking mechanism (not shown) of the door 144. The locking mechanism may be configured to selectively lock the door 144 to the dipper body 142. The locking mechanism may be any locking mechanism known in the art, such as a latch bar and lever arrangement, and so on. Based on an operation of the trip motor 134, the trip cable 136 retracts and actuates the locking mechanism. Based on an actuation of the locking mechanism, the door 144 may be unlocked to dump the material at the unloading position.

The dipper body 142 may include a forward edge 146. The forward edge 146 may include teeth thereby defining a cutting edge that cuts into the ground to fill the dipper body 142. Further the dipper body 142 may also include dipper walls (not shown) having corresponding rearward edges. The door 144 may be pivotally connected to the dipper body 142 and abuts the rearward edges of the dipper walls to close a bottom portion of the dipper body 142.

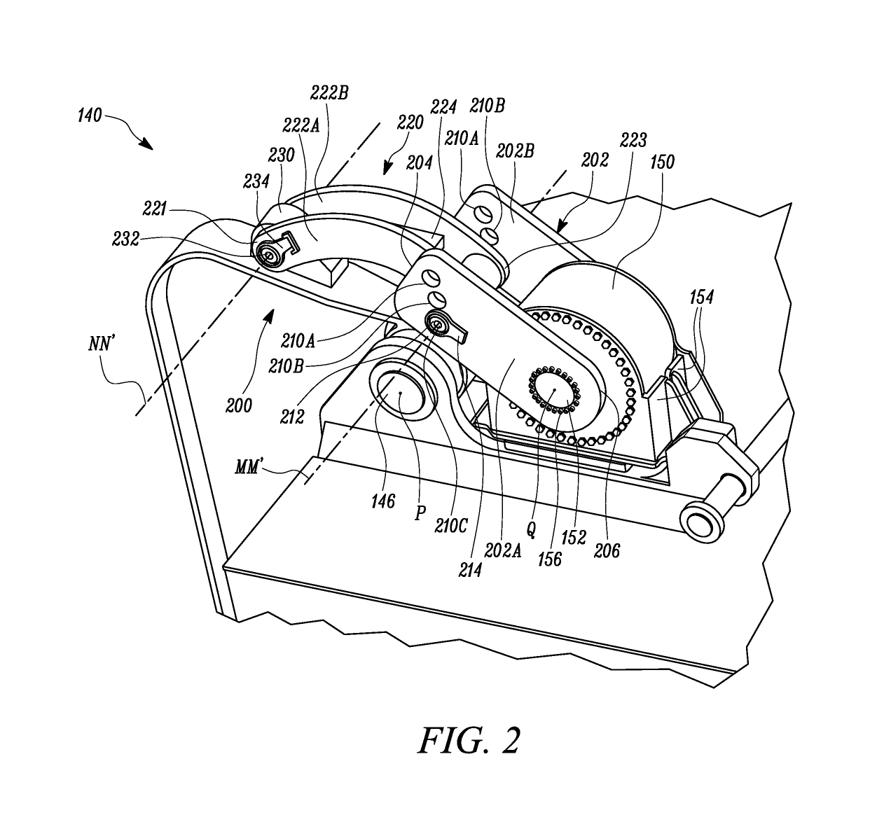

The door 144 is configured to move between an open position and a closed position. In the illustrated embodiment, the door 144 is configured to pivot about a pin joint 148 to swing between the open position 106 and the closed position 108. The pin joint 148 may define a center ‘P’ (See FIGS. 2, 3 and 4). The door 144 may swing relative to the bottom portion of the dipper body 142 between the open position the closed position to discharge the load in the dipper body 142.

The machine 100 further includes a snubber 150 that may be configured to dampen a swinging motion of the door 144, as the door 144 swings between the open and closed positions. In an embodiment, two of the snubbers 150 may be coupled to the dipper system 140. Moreover, the snubbers 150 are mounted on opposing ends of the rearward edges. Therefore, the snubbers 150 may dampen the swinging motion at respective ends of the door 144.

The snubber 150 may be configured to be mounted on the implement i.e., the dipper system 140. In the illustrated embodiment, the snubber 150 has a substantially cylindrical shape. However, a person of ordinary skill in the art will recognize that the snubber 150 may have any configuration or shape depending upon a specific requirement of an application.

In one example, the snubber 150 may be disposed between a pair of brackets 154 while the brackets 154 may be bolted and/or welded on the implement 140. However, the snubber 150 may be mounted on the implement 140 by using suitable methods known in the art. The snubber 150 may also include a shaft 152 defining a longitudinal axis and a center ‘Q’. Further, the shaft 152 may be rotatably received within the housing 304 of the snubber 150. The shaft 152 may also be operatively coupled to the door 144 of the implement 140 via a linkage system that will be explained in detail hereinafter.

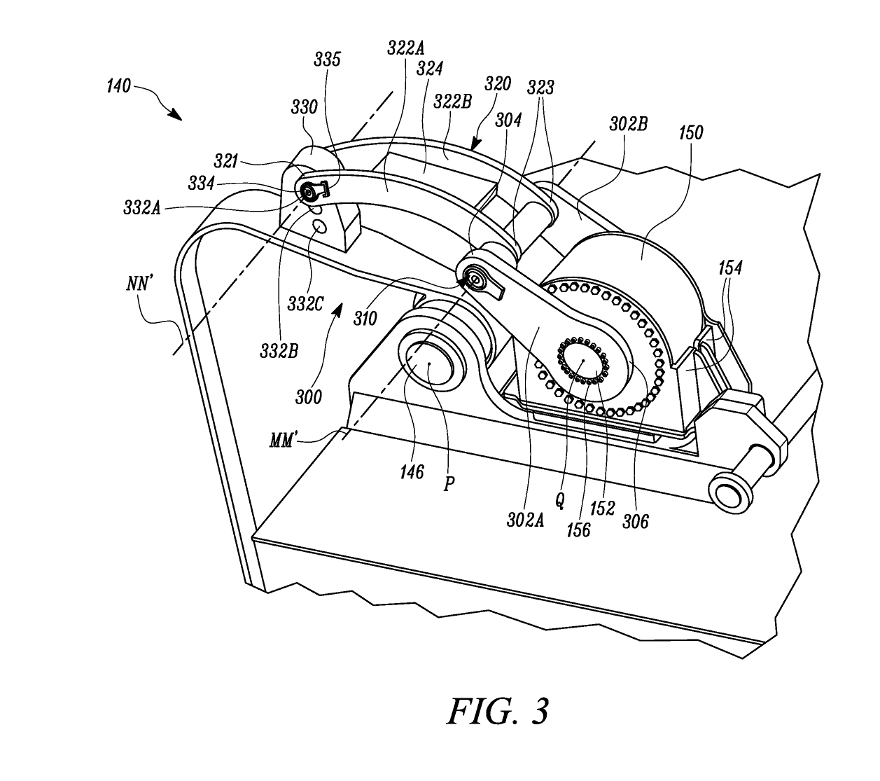

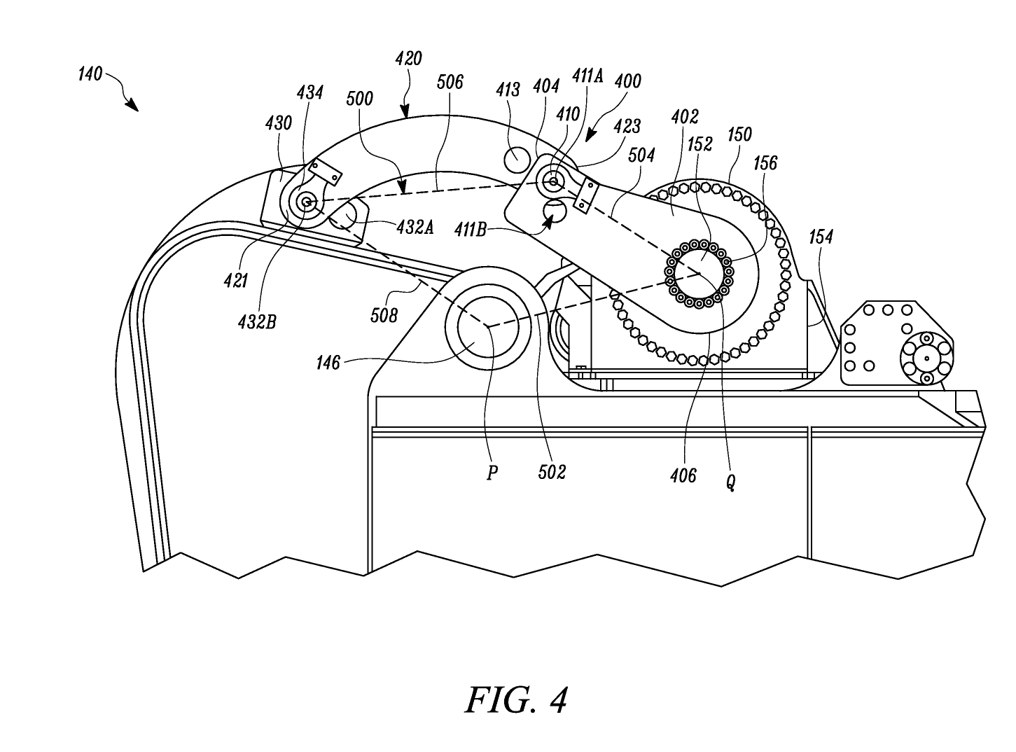

Referring to FIG. 2, a linkage system 200 for the snubber 150 of the machine 100, according to one embodiment of the present disclosure is illustrated. Referring to FIG. 3, a linkage system 300 for the snubber 150 of the machine 100, according to another embodiment of the present disclosure is illustrated. Referring to FIG. 4, a linkage system 400 for the snubber 150 of the machine 100, according to yet another embodiment of the present disclosure is illustrated.

Each of the linkage systems 200, 300, 400 may be configured to transmit a movement of the door 144 to the shaft 152. The shaft 152 may be configured to rotate about the longitudinal axis while the door 144 moves between the open position and the closed position. The snubber 150 may be configured to dampen the swinging motion of the door 144 that may be transmitted to the door 144 via the shaft 152.

Referring now to FIG. 2, the linkage system 200 includes a first linkage component 202 operatively coupled to the snubber 150. In the illustrated embodiment, the linkage system 200 includes a pair of the first linkage components 202A, 202B (also collectively referred to as “the first linkage component/s 202”). Each of the first linkage components 202A, 202B define an opening (not shown) adjacent to a first end 206. The opening may be configured to receive the shaft 152 therein. As shown, a bushing 156 may be disposed in the opening and surrounding the shaft 152. In the illustrated embodiment, the bushing 156 may be a bloc locking device mounted on a plurality of splines of the shaft 152.

Each of the first linkage components 202A, 202B defines a plurality of apertures 210 adjacent to a second end 204 thereof. Although, three apertures 210A, 210B 210C (also collectively referred to as “the aperture/s 210”) are shown, it may be envisioned to provide the first linkage component 202 with any number of apertures 210 depending upon a specific requirement of an application.

The linkage system 200 also includes a second linkage component 220 having a first end 221 and a second end 223. The first end 221 is distal to the first linkage component 202 and the second end 223 is proximate to the first linkage component 202. The second linkage component 220 is coupled to the first linkage component 202 at a link pivot axis MM′. In the illustrated embodiment, the second linkage component 220 includes a first arm 222A, a second arm 222B and a connecting member 224 configured to attach the first arm 222A to the second arm 222B.

Further, the first end 221 of each of the first arm 222A and the second arm 222B of the second linkage component 220 is pivotally coupled to the door 144 about a door pivot axis NN′. In an embodiment, the linkage system 200 further includes a first pin 232 configured to pivotally couple the first end 221 of the second linkage component 220 to the door 144 about the door pivot axis NN′.

The linkage system 200 further includes a third linkage component 230 mounted on the door 144. The third linkage component 230 defines a hole (not shown) to receive the first pin 232 therethrough. Moreover, the linkage system 200 may also include a first fastening member 234 configured to axially retain the first pin 232 along the door pivot axis NN′.

Further, the second end 223 of the second linkage component 220 is selectively and pivotally coupled to one of the plurality of apertures 210 about a link pivot axis MM′ in order to change a perpendicular distance between the door pivot axis and the link pivot axis. The first arm 222A is pivotally coupled to the first linkage component 202A adjacent to the second end 223. The second arm 222B is pivotally coupled to the first linkage component 202B adjacent to the second end 223.

The linkage system 200 may also include a second pin 212 configured to selectively and pivotally couple the second end 223 of the second linkage component 220 to one of the plurality of apertures 210 of the first linkage component 202. In an embodiment, the second linkage component 220 may include a bearing member (not shown) adjacent to the second end 223. The bearing member is configured to at least partially receive the second pin 212 therein. The linkage system 200 may also include a second fastening member 214 configured to axially retain the second pin 212 along the link pivot axis MM′.

In an embodiment, each of the plurality of apertures 210A, 210B, 210C is located at an equal distance with respect to the door pivot axis NN′. Moreover, a second link may be defined between an aperture 210 to which the second linkage component 220 is coupled and the center Q. As such, a length of the second link may be changed by alternatively coupling the second linkage component 220 to a different aperture 210.

In the illustrated embodiment, the second linkage component 220 is coupled to the aperture 210C. However, coupling the second linkage component 220 to the apertures 210B or 210A may also change a perpendicular distance between the door pivot axis NN′ and the link pivot axis MM′. Further, coupling the second linkage component 220 to the apertures 210B or 210A increases the length of the second link in the linkage system 200. With such an arrangement, a torque at least one of the snubber 150, the pivot joint 146 of the door 144 may be varied.

Referring now to FIG. 3, the linkage system 300 includes a first linkage component 320 operatively coupled to the snubber 150. In the illustrated embodiment, the linkage system 300 includes a pair of the first linkage components 320A, 320B (also collectively referred to as “the first linkage component/s 320”) operatively coupled to each end of the snubber 150. Similar to the first linkage component 200 of FIG. 2, the shaft 152 of the snubber 150 may be coupled to the first linkage components 302 adjacent to a first end 306 thereof.

The linkage system 300 also includes a second linkage component 320 having a first end 321 and a second end 323. As illustrated, the first end 321 is distal to the first linkage component 302 and the second end 323 is proximate the first linkage component 302. In the illustrated embodiment, the second linkage component 302 includes a first arm 322A, a second arm 322B and a connecting member 324 configured to attach the first arm 322A to the second arm 322B.

The second end 323 of the second linkage component 320 is pivotally coupled to the first linkage component 302 about a link pivot axis MM′. Specifically, the first arm 322A is pivotally coupled to the first linkage component 302A. Further, the second arm 322B is pivotally coupled to the first linkage component 302B. The linkage system 300 may also include a first pin 310 configured to pivotally couple the second end 304 of the second linkage component 320 to the first linkage component 302 about the link pivot axis MM′. More specifically, each of the first linkage components 302A, 302B defines an aperture (not shown) adjacent to a second end 304 thereof. The apertures may be configured to receive the first pin 310 to couple the first linkage component 302 to the second end 323 of the second linkage component 320.

The linkage system 300 also includes a third linkage component 330 mounted on the door 144. The third linkage component 330 defines a plurality of holes 332 therein. Although, three holes 332A, 332B, 332C (also collectively referred to as “the hole/s 332”) are shown, it may be envisioned to provide the third linkage component 330 with any number of holes depending upon a specific requirement of an application.

In an embodiment, each of the plurality of holes 332 is located at an equal distance with respect to the link pivot axis MM′. The first end 321 of the second linkage component 320 is selectively and pivotally coupled to one of the plurality of holes 332 about a door pivot axis NN′ to change a perpendicular distance between the link pivot axis MM′ and the door pivot axis NN′. In the illustrated embodiment, the second linkage component 320 is coupled to the hole 332A. The linkage system 300 may further include a second pin 334 configured to pivotally couple the first end 321 of the second linkage component 320 to one of the plurality of holes 332 defined in the third linkage component 330 about the door pivot axis NN′. As shown, the linkage system 300 may also include a second fastening member 335 configured to axially retain the second pin 334 along the door pivot axis NN′.

The linkage system 300 may define a linkage member of the linkage system 300 joining the center P and a center of the hole 332A among the plurality of holes 332 to which the second linkage component 320 is coupled. Moreover, by coupling the second linkage component 320 to different holes 332B or 332C defined in the third linkage component 330, a length of the linkage member may be changed. For example, coupling the second linkage component 320 to the apertures 332B or 332C may also change a perpendicular distance between the door pivot axis NN′ and the link pivot axis MM′. Further, coupling the second linkage component 320 to the holes 332B or 332C decreases the length of the linkage member. With such an arrangement, a torque at least one of the snubber 150, the pivot joint 146 of the door 144 may be adjusted to suit a specific requirement of an application.

Referring to FIG. 4, a linkage system 400 for the snubber 150, according to yet another embodiment of the present disclosure is illustrated. The linkage system 400 includes a first linkage component 402 operatively coupled to the snubber 150. In the illustrated embodiment, the linkage system 400 includes a pair of the first linkage components 402 (only one shown in FIG. 4) operatively coupled to the snubber 150 adjacent to a first end 406. Each of the first linkage components 402 defines a plurality of apertures 411 therein adjacent to a second end 404 similar to the linkage system 200 of FIG. 2. In the illustrated embodiment, the first linkage component 402 defines two apertures 411A, 411B.

The linkage system 400 also includes a second linkage component 420 having a first end 421 distal to the first linkage component 402 and a second end 423 proximate the first linkage component 402. The second linkage component 420 defines a plurality of openings 413 adjacent to the second end 423. One of the plurality of openings 413 of the second linkage component 420 is selectively and pivotally coupled to one of the plurality of apertures 411 of the first linkage component 402 about a link pivot axis (not shown). In the illustrated embodiment, the second linkage component 420 defines two openings 413 (one of the opening 413 is visible while the other hole is pivotally coupled to the aperture 411A).

The linkage system 400 also include a third linkage component 430 mounted on the door 144. The third linkage component 430 defines a plurality of holes 432 therein. The first end 421 of the second linkage component 420 is selectively and pivotally coupled to one of the plurality of holes 432 about a door pivot axis (not shown). In the illustrated embodiment, the third linkage component 430 defines two holes 432A, 432B. Further, the first end 421 of the second linkage component 420 is pivotally coupled to the hole 432B about the door pivot axis.

As illustrated, the linkage system 400 may also include a first pin 434 configured to pivotally couple the first end 421 of the second linkage component 420 to the hole 432B defined in the third linkage component 430 about the door pivot axis. The linkage system may further include a second pin 410 configured to selectively and pivotally couple the second end 423 of the second linkage component 420 to the aperture 411A of the first linkage component 402.

As such, by alternatively coupling the second linkage component 420 to other openings 432B and/or the other aperture 411B, a length of different linkage members defined in the linkage system may be varied. With these implementations, a torque at the snubber 150 and/or the pivot joint 146 of the door 144 may be varied as needed.

A person of ordinary skill in the art will acknowledge that, a number of apertures 411, openings 413, holes 432 as illustrated in FIG. 4 is merely exemplary in nature and hence non-limiting of this disclosure. Although, the linkage systems 200, 300, 400 are explained in conjunction with the dipper system 140 as the implement, it may be envisioned to implement the linkage systems 200, 300, 400 in any types and configurations of the dipper systems or even other implements having a door and a snubber attached thereto.

### INDUSTRIAL APPLICABILITY

The present disclosure relates to the linkage systems 200, 300 and 400 for coupling the snubber 150 to the implement 140. Each of the linkage systems 200, 300, 400 may define a four bar linkage including four linkage members. For example, referring to FIG. 4, a first configuration 500 of the four bar linkage is illustrated. A first linkage member 502 may be defined between the center P and the center Q. A second linkage member 504 may be defined between the center Q and a first pivot point between the first linkage component 402 and the second linkage component 420. Further, a third linkage member 506 may be defined between the first pivot point; and a second pivot point between the second and third linkage components 402, 420. Further, a fourth linkage member 508 may be defined between the second pivot point and the center P.

In such an implementation, a torque at the pivot joint 146 of the door 144 and/or at the snubber 150 may depend on relative perpendicular distances between each of the linkage members. Further, these torques may also be varied by varying at least one of the lengths of corresponding linkage members of the four bar linkage. In a second configuration, the aperture 411B may be coupled to the second end 423 of the second linkage component 420 to define a second linkage member and a third linkage member different from the second linkage member 504 and the third linkage member 506 respectively. Moreover, such a configuration for the linkage system 400 yields more torque at the snubber 150 compared to the first configuration 500.

In a third configuration, the second linkage component 420 may be coupled to the hole 432A of the third linkage component 430. Further, the other opening 413 (visible in FIG. 4) of the second linkage component 420 may be coupled to the aperture 411A of the first linkage component 402 to define a second linkage member, a third linkage member and a fourth linkage member different from the second linkage member 504, the third linkage member 506 and the fourth linkage member 508 respectively. The third configuration for the linkage system 400 yields less torque at the snubber 150 compared to the first configuration 500.

Similar concepts may be implemented to the linkage systems 200, 300 as described with reference to the linkage system 400 to provide variable torques at the snubber 150 and/or the pivot joint 146 of the door 144. For example, different configurations for the linkage system 200 may be alternatively implemented by coupling the second end 223 of the second linkage component 220 to either the aperture 210B or 210A instead of the aperture 210C. Similarly, different configurations for the linkage system 300 may be alternatively implemented by coupling the first end 321 of the second linkage component 320 to either the hole 332B or 332C instead of the hole 332A.

Moreover, by providing alternate mounting apertures in at least one of the linkage components of the linkage systems 200, 300, 400, these different configurations may be implemented with use of the same linkage components. Additionally, the linkage components may detachably coupled with each other. As such, depending upon the resistance required for the door 144, the linkage systems 200, 300 and 400 may be alternatively implemented in different configurations.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A linkage system for a snubber of a machine, the snubber being mounted on an implement of the machine, the linkage system comprising:
a first linkage component operatively coupled to the snubber, the first linkage component defining a plurality of apertures therein; and
a second linkage component having a first end distal to the first linkage component and a second end proximate the first linkage component, wherein the first end of the second linkage component is pivotally coupled to a door of the implement about a door pivot axis, and wherein the second end of the second linkage component is selectively and pivotally coupled to one of the plurality of apertures about a link pivot axis in order to change a perpendicular distance between the door pivot axis and the link pivot axis.

2. The linkage system of claim 1, wherein each of the plurality of apertures are located at an equal distance with respect to the door pivot axis.

3. The linkage system of claim 1 further comprising a first pin configured to pivotally couple the first end of the second linkage component to the door of the implement about a door pivot axis.

4. The linkage system of claim 3 further comprising a third linkage component mounted on the door of the implement, the third linkage component defining a hole to receive the first pin therethrough.

5. The linkage system of claim 3 further comprising a first fastening member configured to axially retain the first pin along the door pivot axis.

6. The linkage system of claim 1 further comprising a second pin configured to selectively and pivotally couple the second end of the second linkage component to one of the plurality of apertures of the first linkage component.

7. The linkage system of claim 6, wherein the second linkage component comprises a bearing member adjacent to the second end, the bearing member configured to at least partially receive the second pin therein.

8. The linkage system of claim 6 further comprising a second fastening member configured to axially retain the second pin along the link pivot axis.

9. The linkage system of claim 1 further comprising a pair of the first linkage components operatively coupled to each end of the snubber.

10. The linkage system of claim 9, wherein the second linkage component comprises:
a first arm pivotally coupled to one of the pair of the first linkage components and the door of the implement;
a second arm pivotally coupled to another of the pair of the first linkage components and the door of the implement; and
a connecting member configured to attach the first arm to the second arm.

11. A linkage system for a snubber of a machine, the snubber being mounted on an implement of the machine, the implement having a door, the linkage system comprising:
a first linkage component operatively coupled to the snubber;
a second linkage component having a first end distal to the first linkage component and a second end proximate the first linkage component, wherein the second end of the second linkage component is pivotally coupled to the first linkage component about a link pivot axis;
a third linkage component mounted on the door of the implement, the third linkage component defining a plurality of holes therein, wherein the first end of the second linkage component is selectively and pivotally coupled to one of the plurality of holes about a door pivot axis to change a perpendicular distance between the link pivot axis and the door pivot axis.

12. The linkage system of claim 11, wherein each of the plurality of holes are located at an equal distance with respect to the link pivot axis.

13. The linkage system of claim 11 further comprising:
a first pin configured to pivotally couple the second end of the second linkage component to the first linkage component about the link pivot axis; and
a first fastening member configured to axially retain the first pin along the link pivot axis.

14. The linkage system of claim 11 further comprising a second pin configured to pivotally couple the first end of the second linkage component to one of the plurality of holes defined in the third linkage component about the door pivot axis.

15. The linkage system of claim 14 further comprising a second fastening member configured to axially retain the first pin along the door pivot axis.

16. The linkage system of claim 11 further comprising a pair of the first linkage components operatively coupled to each end of the snubber.

17. The linkage system of claim 16, wherein the second linkage component comprises:
a first arm pivotally coupled to one of the pair of the first linkage components and the door of the implement;
a second arm pivotally coupled to another of the pair of the first linkage components and the door of the implement; and
a connecting member configured to attach the first arm to the second arm.

18. A linkage system for a snubber of a machine, the snubber being mounted on an implement of the machine, the implement having a door, the linkage system comprising:
a first linkage component operatively coupled to the snubber, the first linkage component defining a plurality of apertures therein;
a second linkage component having a first end distal to the first linkage component and a second end proximate the first linkage component, the second linkage component defining a plurality of openings adjacent to the second end, wherein one of the plurality of openings of the second linkage component is selectively and pivotally coupled to one of the plurality of apertures of the first linkage component about a link pivot axis; and
a third linkage component mounted on the door of the implement, the third linkage component defining a plurality of holes therein, wherein the first end of the second linkage component is selectively and pivotally coupled to one of the plurality of holes about a door pivot axis.

19. The linkage system of claim 18 further comprising a first pin configured to pivotally couple the first end of the second linkage component to one of the plurality of holes defined in the third linkage component about the door pivot axis.

20. The linkage system of claim 18 further comprising a second pin configured to selectively and pivotally couple the second end of the second linkage component to one of the plurality of apertures of the first linkage component.
